(19) United States
(12) Patent Application Publication
(10) Pub. No.: US 2009/0031015 A1
(43) Pub. Date: Jan. 29, 2009

(54) SYSTEM AND METHOD FOR ARRANGING AND OUTPUTTING DATA ELEMENTS AT A NETWORK SITE

(76) Inventors: Ryan W. Morgan, Scottsdale, AZ (US); Thomas D. Bradshaw, Washington, DC (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/106,790

(22) Filed: Apr. 21, 2008

Related U.S. Application Data
(60) Provisional application No. 60/913,075, filed on Apr. 20, 2007.

(51) Int. Cl. G06F 15/173

(52) U.S. Cl. 709/223

(57) ABSTRACT

A system and method for arranging and providing a plurality of display elements are provided. A plurality of users are prompted to enter element information related to a plurality of corresponding display elements. Element data for each display element is received from each of the corresponding plurality of users. A plurality of display elements are generated based on the corresponding element data. Element information related to each of the display elements is stored. A request from a user for a plurality of display elements is received. Responsive to the request, a plurality of display elements is selected for output to the user based on the stored element information. An output arrangement for the plurality of selected display elements is determined based on a predetermined arrangement algorithm. The plurality of selected display elements are outputted at a network site so that they are displayed to the user in the output arrangement. The output arrangement comprises a geometrically-defined mosaic of concatenated display elements.

### RELATED APPLICATIONS

This application claims the benefit of U.S. Provisional Application No. 60/913,075, filed Apr. 20, 2007, which is incorporated herein by reference in its entirety.

### FIELD OF THE INVENTION

The present invention relates to using a computer to arrange and display output elements such as user-generated images at a network site.

### BACKGROUND OF THE INVENTION

Various websites display a plurality of user-generated display elements. For example, the website www.milliondollarhomepage.com displays a mosaic of user-uploaded display elements comprising text and/or images. Users purchase space on the page at a price based on the size of their intended display element, much like advertisers purchase space on a page of ads in a newspaper based on the size of their ad. Collectively, the patchwork of display elements fit in a single rectangular webpage viewable in a user's web browser. “Mousing over” a particular display element in a user's browser causes a message to appear next to the user's cursor, wherein the message comprises information about the selected display element. For instance, mousing over a rectangular image comprising a text logo that says “Web Hosting” brings up the message “The Best Web Site Hosting, Ever. Only $1.99—www.easycgi.com”. Some of the images also comprise a hyperlink. For instance, clicking on the “Web Hosting” image causes a user's browser to redirect to the website www.easycgi.com.

The video-sharing site www.YouTube.com enables users to upload and share videos. Users may search videos using keywords, e.g., that match a title of a video. The site displays the search results as a list of “thumbnails,” wherein each thumbnail represents one video. The thumbnail may display an image or plurality of images from the video. For instance, the thumbnail may display of slideshow of images from the video. Users select a specific video for playback by clicking on a one of the static “thumbnail” images. Videos are played back in a playback window inside the user's browser. YouTube's playback window is the same size on the user's browser regardless of the video selected.

YouTube and other file-sharing websites typically employ a consistent output format for displaying a set of user-uploaded display elements. Most websites, such as www.youtube.com, display user-uploaded image elements in a traditional format comprising rows and/or columns.

### BRIEF SUMMARY OF THE INVENTION

Accordingly, various embodiments of the present invention are directed to a system and a method for arranging and/or displaying output elements at a network site.

According to some embodiments of the invention, systems and methods for arranging a plurality of display elements are provided. A plurality of users are prompted to enter element information related to a plurality of corresponding display elements. Element data for each display element is received from each of the corresponding plurality of users. A plurality of display elements are generated based on the corresponding element data. Element information related to each of the display elements is stored. A request from a user for a plurality of display elements is received. Responsive to the request, a plurality of display elements is selected for output to the user based on the stored element information. An output arrangement for the plurality of selected display elements is determined based on a predetermined arrangement algorithm. The plurality of selected display elements are outputted at a network site so that they are displayed to the user in the output arrangement. The output arrangement comprises a geometrically-defined mosaic of concatenated display elements.

According to some embodiments, a plurality of users upload text and/or images to a server. The server enables each user to format or otherwise modify the uploaded text and/or images to create a display element. The server stores the display elements and/or information related to the display elements, such as the uploaded images, text, and formatting data. The server outputs a webpages comprising a plurality of display elements arranged according to predetermined output arrangement. The output arrangement may correspond to a physical object or other predetermined design.

Other embodiments may be considered.

### BRIEF DESCRIPTION OF THE DRAWINGS

FIGS. 1A and 1B depict exemplary systems for arranging and displaying output elements at a network site according to an embodiment of the invention.

FIG. 2 depicts an exemplary flow chart for arranging and displaying output elements at a network site according to an embodiment of the invention.

FIG. 3 shows an exemplary webpage comprising a plurality of image elements arranged in a predetermined pattern according to an embodiment of the invention.

FIG. 4 shows an exemplary webpage for uploading an image according to an embodiment of the invention.

FIG. 5 shows an exemplary webpage for formatting an uploaded image according to an embodiment of the invention.

FIG. 6 shows an exemplary webpage for formatting a thumbnail of an output element according to an embodiment of the invention.

FIG. 7 shows an exemplary webpage for entering user information according to an embodiment of the invention.

FIG. 8 shows an exemplary webpage for entering information about a display element according to an embodiment of the invention.

FIG. 9 shows an exemplary webpage for displaying a full-size version of a display element according to an embodiment of the invention.

FIG. 10 shows an exemplary webpage for communicating to other users about a display element.

FIG. 11 shows an exemplary flow chart for outputting a plurality of elements at a network site.

### DETAILED DESCRIPTION OF EXEMPLARY EMBODIMENT(S)

Some embodiments of the present invention provide systems and methods for arranging and/or displaying output elements at a network site.

Server 2 may comprise one or more processors, computers, computer systems, computer networks, and or computer databases. Server 2 may comprise modules 18-64. Server 2 may also comprise one or more databases, such as databases 80. Server 2 may communicate with users 10. For instance, server 2 may communicate with a user 10 computer, such as a browser of a user computer, e.g., over the internet.

Modules 18-68 may comprise one or more processors, computers, computer systems, and/or computer networks.

Databases 80 may comprise one or more processors, computers, computer systems, computer networks, and/or computer databases configured to store information. Each of databases 80 may communicate with server 2 and modules 18-64. For instance, server 2 and modules 18-64 may store information in databases 80 and may also use information stored in databases 80.

An element (e.g., an output element or display element) may comprise a document or other file comprising one or more text characters, images, videos, sound files, programs, other files, or any combination or portion thereof. For instance, an element may comprise an image in the form of a .gif file, e.g., that has been cropped and resized by a user. An element may comprise a 20-second video clip. An element may also comprise one or more static images that are comprised in or otherwise derived from the video clip. A plurality of elements associated with a particular site may have common formatting characteristics, e.g., a common size and shape when displayed on a user's 10 browser.

An element may comprise audio and/or video signals, static and/or dynamic images, graphics, video, film, or other content that relate to one or more products, services, and/or entities, such as commercial entities. Elements may comprise various visual features, including animation, sound, etc., and may also include text, such as in a text advertisement. Thus, the term “element” is used herein in its broadest sense to mean any content or object intended for observation, use, or consumption by one or more persons.

Information associated with an element may comprise code and/or any feature related to such display element, such as its size, location (e.g. on a website), formatting, font, size, highlighting (e.g., italics or bold), and/or associated content (e.g., hyperlink, linked content, or content located next to, above, below, or otherwise near the content).

While elements and websites are used for exemplary purposes, it should be understood that embodiments of the invention may be directed to other electronic documents and network sites. For instance, various embodiments of the invention contemplate documents such as content pages, search results, emails, applications, IM messages, audio content or files, video content or files (e.g., television programming), other files, other data or applications that may reside on one or several (e.g., a network) of computer systems, or other definable concepts or content.

### Overview and System Architecture

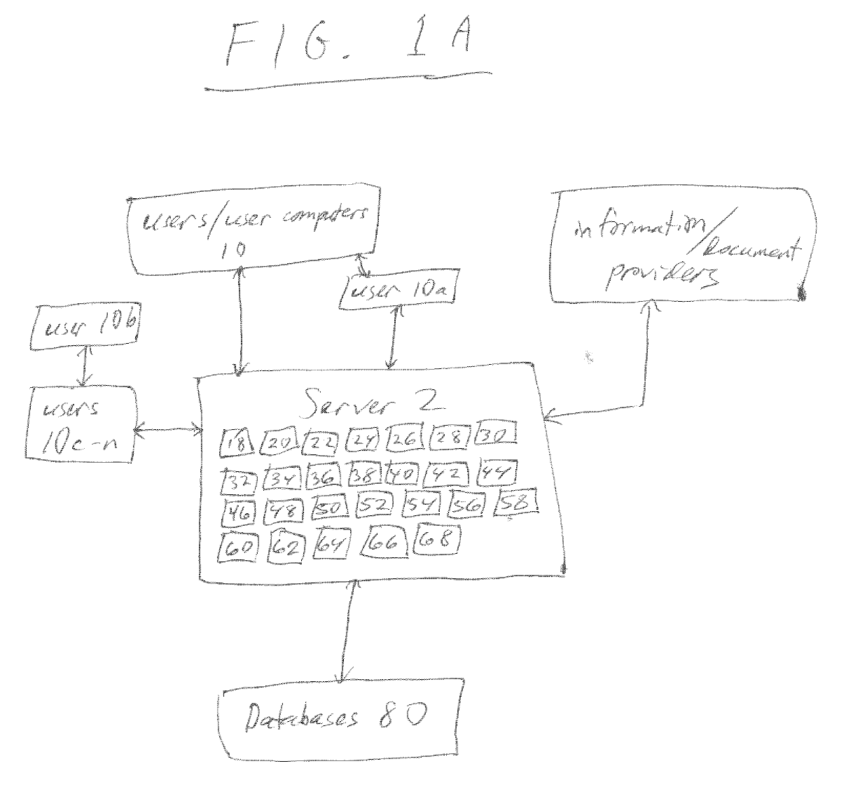

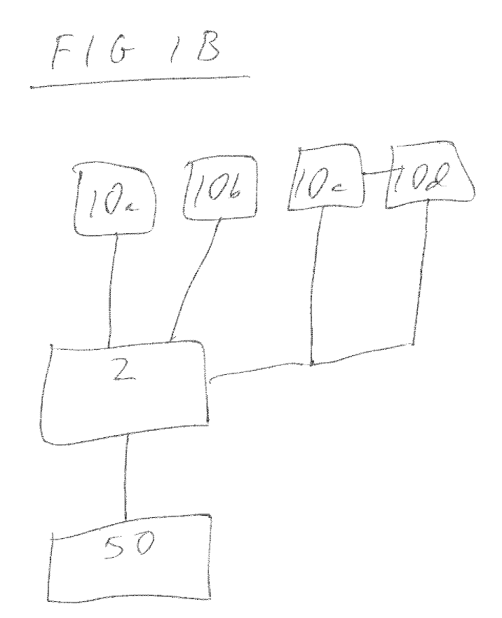

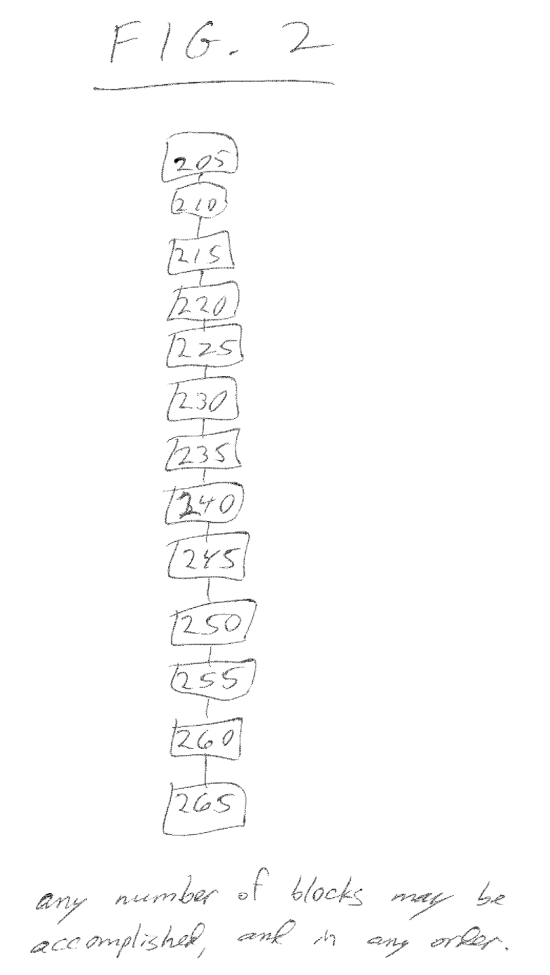

FIG. 1A depicts a system 100 for automatically generating and displaying elements according to predetermined arrangement.

The system 100 may comprise one or more servers 2 coupled to one or more databases 80, one or more content providers 8a-8n, one or more end users 10a-10n, one or more document requestors 12, and one or more document submitters. The content providers 8a-8n, document requesters 12, and domain submitters 14 may communicate with the server 2 and/or end users 10.

End users 10a-10n may comprise persons who may receive documents or other content, by receiving a webpage at a user computer. End users 10a-10n may also refer to the user's computer web browser 10, such as Internet Explorer™, which may communicate with content providers 8 and server 2.

Content provider 8 may comprise any server, document provider (e.g., a website publisher or other content provider), search engine, or other entity that publishes or makes available information, services, and/or products over an electronic network, such as the Internet. Content provider 8 may comprise one or more of the following, for example: an advertisement listings provider, an electronic document publisher or provider, a website host, a server 2, any other entity that provides electronic documents to users or other entities, or any other provider of content.

Element providers and requesters 12 may comprise any server, web browser, document publisher, or other entity that may request documents, e.g., from server 2. For instance, document requestor 12 may request one or more ads from server 2. The document request may comprise an http referrer field, which may be identified by the server. For instance, if an end user 10 clicks on an advertisement displayed at www.cnn.com, the user's web browser may request the clicked advertisement from server 2, and the request may identify that the request originated from www.cnn.com.

The server 2 may comprise a computer, server, hub, central processor, or other entity in a network, or other processor. The server 2 may comprise a crawler and/or a compliance engine. For instance, the server 2 may comprise a bot that crawls the Internet and determines whether Internet websites conform to predetermined criteria. The server 2 may also comprise a content provider system. The server 2 may comprise input and output devices for communicating with other various system 100 elements, e.g., 6, 8, 10, 12, and 14.

In some embodiments, the server 2 may be comprised in an end user's computer 10, e.g., as a toolbar in a user's web browser.

The server 2 may comprise a plurality of modules, such as module 18. Each module may comprise a processor as well as input and output devices for communicating with other modules, databases, and other system elements.

The modules may function separately or in various combinations. While the modules are shown within a single server, the modules may also operate among several servers. The modules may communicate with a plurality of databases, which may also function collectively or separately.

Databases 80 may store information about users, elements, and other information.

Element Upload Module 18 enables a user 10 to upload a graphic. The graphic may be uploaded by identifying an address (e.g., URL address, etc.). The graphic may be downloaded from the advertiser's website or other associated site. The graphic may be retrieved from a database or other source. The graphic may include various visual options, including animation, pop-up ability, sound waves, etc. and may also include text, including text advertisement. The server may size or shape the graphic to fit a predetermined size or shape. In addition, the advertiser may select from a selection of sizes and/or shapes for display. For example, the advertiser may be willing to pay more for a larger size graphic rather than settle for a smaller standard size. By enlarging the graphics, an advertiser may increase potential click through by end-users.

User communication module 20 may communicate with users 10, e.g., over a network such as the internet. User communication module may communicate with users 10 in order to receive elements, information or documents associated with an element (such as a file from which an element may be created or determined), user information, user preference information, and other information. User preference information may include a user's preferences associated with a user account, one or more elements associated with the user, one or more element sites associated with the user 10, and other information associated with the user.

User account module 22 may identify, obtain, communicate, and store information related to a user 10, one or more elements associated with a user 10, and/or an account associated with the user (e.g., an element uploaded or purchased by a user). For instance, User account module 22 may receive and store personal information about the user 10. Such personal information may be obtained from a particular user and may include a user's name, address, account number (e.g., bank account number, credit or debit card number, paypal account information, or other transaction account identifier), social security number, phone number, password, security question and answer selected by the user, and other information related to the user). User account module 22 may also include information about a user's account with server 2, e.g., an account for maintaining an element at an element site. Such account information may include an account number associated with the user and one or more elements and/or element network sites.

User account module 22 may enable a user to create an account associated with the server 2 and/or a network site (e.g., a network site for which the user 10 uploads an element for display). After a user creates an account, the user may login to the user's account, e.g., at the server 2. Logging in to an account may be accomplished by any traditional means, e.g., by entering a usemame and password associated with the user's account at an appropriate prompt provided by server 2.

Cookie module 24 may cause files, programs, or other information to be stored or executed on a user 10 computer. Such files, programs, and other information may include one or more element identifiers, one or more element links, user account information, user preference information, and programs that may cause such information to be communicated (e.g., automatically) to server 2, e.g., by interacting with a user's internet browser when the user 10 directs the browser to the server 2.

For instance, cookie module 24 may pass information to the server 2 about the user (such as a user's usemame and/or password) and/or about one or more elements associated with the user or the user's computer (e.g., an element identifier that identifies an element uploaded by the user 10). Based on this information, the server 2 may identify the user and/or one or more elements associated with the user. When the user 10 directs the user's browser to the network site, the network site may output a webpage containing user-specific information. The user-specific information may comprise messages (e.g., “Welcome, [username]!” and/or “click here to see your element”), links (e.g., a link to a webpage or other document containing an element associated with the user 10), and other content associated with the user 10.

In one embodiment, cookie module 10 may cause a user's 10 browser to highlight an element associated with the user 10 on a webpage comprising a plurality of elements. For instance, when a webpage containing a user-associated element loads on the user's 10 browser, a cookie stored at the user's 10 computer may identify that a user-associated element is on the webpage, and this may trigger a program at the user's browser to highlight the specific user-associated element, e.g., by highlighting a border surrounding the element.

Element site module 26 may manage and coordinate the display of elements at one or more network sites, e.g., network sites that host and/or serve a plurality of elements associated with a particular idea or theme. For instance, one network site may serve elements associated with electing Barack Obama to President, while another serves elements associated with electing Hillary Clinton to President, while yet another network site serves elements associated with commemorating a state championship title of a local high school cross country team. The different network sites may be hosted by other servers 2 (not shown). Element site module 26 may store and manage information about the different network sites, the different themes or ideas associated with the sites, different elements associated with each site, and other information.

Data associated with a single element may be stored in a single database system 80, or it may be distributed among a plurality of servers and databases. For instance, text and image data corresponding to an element may be stored and hosted by one website, while video associated with the element may be stored at another website, such as youtube.com.

For example, a rock band may create an element on a rock and roll fan site that mentions the name of their band. Clicking on the element may direct a user browser to a video hosted on the band's website. In some embodiments, video and audio files can be embedded into the element itself. These files may be hosted by server 2 or another server or website otherwise unrelated to server 2. For instance, an element may comprise or be associated with (e.g., by linking to) multimedia content hosted by third parties (e.g., the websites www.youtube.com, www.myspace.com, www.itunes.com).

In some embodiments, a site such as www.bandwall.com may enable musical groups such as rock bands to upload elements comprising music files and/or links to the band's music files hosted at another site such as the band's myspace page (at www.myspace.com), e.g., in an effort to attract attention from other users and possibly a record label. Aspiring auteurs may upload video elements and links in a similar manner.

Users may express preferences regarding other elements, e.g., by providing comments (feedback) about a particular element or providing numerical ratings (e.g., across a range of categories such as humor, quality of art, drama, “best”, most popular, and most selected). In some embodiments, the server 2 may manage a star ranking system or a 1 to 10 scale across one or more categories, where users who open that particular element and watch the movie or listen to the music (or view the picture in the case of aspiring models, etc.) can thereafter rate the film or music. The element may be automatically updated to reflect the cumulative rankings. Characteristics of the element such as its relative position in the arrangement, its color (or background, shading, and outline colors) or formatting characteristics may be adjusted or otherwise altered to reflect user feedback. In some embodiments, the arrangement of the elements may depend on each element's popularity, rating, or other criteria (or combination thereof) so that the highest-scoring element is displayed in a “first” position (e.g., the bottom middle, bottom left, bottom right, top middle, top right or left), or other noteworthy position in the arrangement. Users may be informed of feedback, e.g., via email or messages posted to a user's account.

Element creation module 28 may facilitate the creation or modification of an element, e.g., by a user 10 and/or the server 2. For example, element creation module 28 may enable a user 10 to select, identify, and/or create text and/or images that may be comprised in an element. For instance, element creation module 28 may prompt a user 10 to enter text to be included in an element. Element creation module 28 may also prompt a user 10 to upload, select, or otherwise identify text and/or graphics to be included in an element.

In some embodiments, element creation module 28 may create a rectangular display element based on text and a logo selected or otherwise identified by a user 10.

For instance, a user 10 may wish to create an element to be displayed at a network site that displays elements having the theme of promoting the election of Barack Obama as President of the United States. Element creation module 28 may enable the user to select or create text to be included in the user's element, select formatting preferences such as font and font size, and select or create one or more graphics for inclusion in the element. For instance, the user 10 may type “Ba-rock the house!” and also select the phrase “Obama for Pres 2008” from among a list of slogans (e.g., “Vote Obama”) provided by server 2. The user 10 may also select from among a plurality of images of Barack Obama for inclusion in the element.

User upload module 30 may enable users 10 to upload one or more documents or files to server 2. The documents or files may comprise elements or documents that may be modified to become elements (e.g., an image that is cropped to a standard size for elements at a particular network site).

Element extraction module 32 may select, extract, create, determine, or otherwise identify one or more elements from a file or document, e.g., a video comprising a stream of images and sound. For instance, Element extraction module 32 may select a one or more specific image elements from among a video stream containing a plurality of images. Element extraction module 32 may select such element based on element properties such as color, file size, image size (e.g., number of pixels, geometric shape, aspect ratio, length, width, etc.), sound (if the file contains an audio element) (e.g., volume, frequency, frequency distribution), or other parameters.

For instance, element extraction module 32 may select an image that contains a substantial amount of a particular color scheme, such as a particular shade of blue, for inclusion in a document such as a webpage containing a plurality of elements having that same shade of blue.

In various other embodiments, element extraction module 32 may select elements based on one or more properties of a desired element arrangement for a plurality of elements. For instance, it may be desired to arrange a plurality of elements such that they create a composite image that looks similar to the face of Darth Vader or a monkey. The elements may comprise the composite image in much the same way that a plurality of colored dots may comprise a composite image of a bowl of fruit in an Impressionist painting. Accordingly, Element extraction module 32 may extract image elements of a video stream based on the particular color, size, or other characteristic needed to fill in the “dot” or element of the composite picture.

In one example, a composite image of a monkey's face may be comprised of a plurality of images of George Bush. The monkey's face may comprise hundreds of image elements of varying colors corresponding to the monkey's face, such as brown (monkey neck fur), black (eyes), tan (face), and white (monkey beard). Image extraction module 32 may extract or otherwise identify images corresponding to those colors from one or more videos and pictures of George Bush.

It should be appreciated that a plurality of different elements may be extracted from a single document or file. For instance, server 2 may select a different image from a video stream each time an element is requested or displayed.

It should also be appreciated that element extraction module 32 may modify an image, e.g., by changing its background color. For instance, if no black images of George Bush are available, element extraction module 32 may modify an image to replace a white background with a black background in an image of George Bush, or to change George Bush's flesh tones from white to black. The image may be modified to the extent necessary so that the composite image appears to have the intended color scheme, such as the color scheme of a monkey's face.

Element format module 34 may format or otherwise modify an element, e.g., according to predetermined element format criteria. For instance, element format module 34 may modify an element's element properties (e.g., size, color, pixels, etc.). Element format module 34 may also convert an element from one file format to another (e.g., jpeg to tiff).

Element format module 34 may specify or determine the look, feel, size, color, and shape of an element. In some embodiments, element format module 34 may format an element so that it has a rectangular, “brick” shape. In other embodiments, element format module may format elements to be other shapes such as spheres, triangles, hexagons, squares, other polygons, tiles, or other shapes.

In some embodiments, element format module 34 may format an element to have formatting characteristics (such as size and shape characteristics) based on criteria related to the user, element information, or factors related to the purchase, sale, or creation of an element. For instance, the size and shape of an element may be determined based on the size of files related to an element, design characteristics of an element, artistic content related to an element, the price paid (or premium paid) for an element, a user characteristic (such as a premium category of a user account), and other factors.

It should be appreciated that more than one type of element format may be present on a single page, such as a webpage comprising a mosaic of elements.

Element format module 34 may modify properties of an element based on a desired composite arrangement of elements, such as the desired characteristics of a composite image comprising a plurality of elements.

Keyword module 36 may identify or associate concepts such as keywords with one or more elements. For instance, Keyword module 36 may associate the words “Obama” and “President” with an element comprising the text “Obama for President in 2008.” Keyword module 36 may utilize OCR software and other technology to identify text in element files that are not native text, such as an image. For instance, Keyword module 36 may use OCR to determine that an element contains an image of the words “B.O. for Prez.” After identifying text that appears in an element, Keyword module 36 may associate some or all of the text with the element as element keywords, e.g., “B.O.,” “Prez,” and “President.”

Element identifier module 38 may cause an identifier (e.g., a unique identifier) to be assigned to each element. For instance, a unique element identification number may be assigned to a specific element. The identifier may enable the server 2 to identify an element based on its identifier, and vice versa. For instance, if a user 10 requests an identifier associated with a particular identifier, server 2 may identify the element associated with the identifier and output that element to the user 10.

Element selection module 40 may select one or more elements for output at a network in a document, such as in a webpage of a website. Element selection module 40 may select elements according to various criteria, such as the order in which elements were provided by users, element identifier number, size, shape, and other criteria. Element selection module 40 may also select one or more elements based on a type of element (e.g., image, video, sound, created element, uploaded element), price class of the element (e.g., the price paid for an element, or a price premium paid for a particular element), other characteristic of an element (e.g., size, shape, dominant color, and other parameters), user characteristic (e.g., age of user, rank or position of user in organization associated with a network site, such as administrator of the site), and other criteria associated with elements and/or their associated users 10. For instance, element selection module may select the first 100 of 1000 elements that were created or uploaded by users 10 for output on a webpage. The remaining 900 elements may be selected for output in subsequent pages of elements. For instance, users 10 may view the remaining elements by selecting “next” to scroll through additional pages of the 900 elements.

In some embodiments, Element selection module 40 may select elements based on their suitability for creating an intended composite arrangement of elements. For instance, Element selection module 40 may select a number of George Bush images that predominantly contain black, brown, tan, and white in order to create a composite image of a monkey's face having those colors. The elements may be arranged according to the desired color scheme, e.g., so that the white image elements are located in the composite monkey's white beard and the black images appear in the monkey's black eyes, for example.

Arrangement selection module 42 may identify or determine an arrangement for a plurality of elements, e.g., for output at a user browser. For instance, Arrangement selection module 42 may enable users to specify, select, define, or otherwise determine an arrangement or one or more arrangement parameters that affect the arrangement of elements, e.g., on a webpage. The arrangement may comprise parameters that define an arrangement, such as a number of elements, a size and shape of elements, a color scheme, one or more composite shapes, and other audio and visual features. For example, one arrangement may comprise a monkey's face or Darth Vader's face, while another may be a black-and-white soccer ball or a brown basketball.

For example, arrangement selection module 42 may enable users 10 to select from among various arrangements, e.g., that correspond to a particular theme such as a sport. For example, users 10 may select from among a list of composite arrangements that appear like a soccer ball, a baseball, a baseball bat, a football, a football helmet, a volleyball, a tennis racket, a tennis court, and other images associated with a sport. A user 10 may select a black-and-white soccer ball.

It should be appreciated that a particular arrangement may define a number or “resolution” of elements, depending on the level of detail of the composite image. For instance, a very “fine” composite image of Darth Vader' s face may require thousands of image elements, a more coarse composite image of Darth Vader' s face may only require hundreds of image elements. As with pixels, the larger the density of image elements in a particular space, the better the composite image clarity, definition, and “resolution.”

Different levels of detail may be used for an arrangement at different times, e.g., according to a user-controlled zoom function. For instance, a low level of detail (with a lower number of elements) may be used when a user's 10 internet connection is slow, and it takes a longer time to download images of a large number of elements. A page may also load a lower resolution composite image and then more finely resolve and resize the “lower-res” composite image as more elements are downloaded. Once the user's 10 browser receives all of the “high-res” image elements, the user's browser may switch from displaying the lower-res to the high-res version of the arrangement.

It should be appreciated that zoom functionality may also be used to proportionally increase and decrease the size of the elements. For instance, users 10 may “zoom in” on a composite image to see a portion of interest in greater detail. In such cases, the portion of interest of the composite image may expand and thereby expand the image elements contained therein. In this way, users 10 may zoom in to view a specific element or set of elements more closely.

Element arrangement module 44 may determine an arrangement of one or more elements, e.g., for output in a document such as a webpage. In some embodiments, element arrangement module 44 may arrange elements into a composite arrangement according to an arrangement identified by arrangement selection module 42. If a user 10 selects a soccer ball arrangement, for instance, element arrangement module 44 may arrange a plurality of elements according to the soccer ball arrangement to create a composite image of a soccer ball, e.g., in a user's 10 web browser.

In some embodiments, element arrangement module 44 may arrange like-sized rectangular elements in a series of rows on top of one another, e.g., so that the elements are arranged like bricks in a wall. For instance, element arrangement module may use a flash scrolling mechanism to build the arrangement of specific elements. For instance, in one brick wall-type arrangement, each row may comprise a specific number of “brick” elements. Each row may be off-center from an adjacent row, like traditional bricks in a wall. The elements may be spaced apart from one another, e.g., in a manner similar to traditional bricks in a wall, wherein white mortar spaces bricks apart from one another. The “mortar” image may comprise a fixed background of the page, while the “bricks” are filled into invisible brick slots on the page.

Element arrangement module 44 may select “brick” elements and create a composite document by associating various elements with their position in the arrangement. In some embodiments, elements may be assigned to brick slots (or other positions in an arrangement) based on the time a brick was created or updated. For instance, the brick with the most recent activity may be placed in the “first” position in the wall, e.g., the lower left. Elements that have the next most recent creation or modification date may be placed in the “next” position, e.g., immediately to the right of the “first” position. Elements may be assigned to “brick slots” in this manner until a row of bricks are defined, and then the element position assignment process may continue for the next row. This process may continue until a full page of bricks slots have been assigned to elements. Any remaining bricks may be displayed on subsequent pages in a similar manner, if and when requested by a user.

It should be appreciated that an arrangement may comprise both element and non-element features. For instance, a brick arrangement may comprise “brick” elements, while a white “mortar” may be added between the brick elements. An image of the white mortar may be comprised of elements (e.g., elements comprising a mostly white background so that they substantially appear white) or non-element image features, such as a white border in the arrangement.

It should be appreciated that elements need not be rectangular to appear in a brick wall-type arrangement. In some embodiments, element arrangement module 44 may modify elements, e.g., by cropping or re-sizing them, so that they fit in a rectangular brick-type arrangement. Alternately, in some embodiments, element arrangement module 44 may add borders, frames, or other visual features to an element to cause an element of one size or shape to have a different effective size or shape (including the additional visual features).

In some embodiments, element arrangement module 44 may arrange elements according to a 3-dimensional arrangement pattern, such as a sphere, cube, famous sculpture (such as “The Thinker” sculpture by Rodin), or other three-dimensional shape and/or image (which may be displayed on a two-dimensional computer screen, for example). For instance, element arrangement module 44 may arrange elements for display on a 3-dimensional soccer ball. In some embodiments, each hexagonal piece of the soccer ball may correspond to a player of a school soccer team. Image elements corresponding to the specific player may be arranged into the player's corresponding hexagon. The composite 3-dimensional soccer ball arrangement may be rotated, e.g., in a manner similar to how users may rotate the earth in the software application Google Earth. For instance, users 10 may click on the soccer ball and move their mouse to rotate the ball in a desired direction. As the soccer ball rotates, different collages of player photos may become visible, e.g., inside a user's browser or other software program.

Accordingly, in some embodiments, a particular arrangement (such as a soccerball) may have a plurality of element slots, each slot corresponding to a position of an element. Elements may be displayed in the element slots. For example, a soccer ball arrangement may have about 30 octagonal shapes covering the three-dimensional image of the soccer ball, and each octagonal shape may have 20 element slots. One or more of the slots may be filled by specific elements, e.g., when a webpage outputs a plurality of elements in the arrangement. For example, the soccer ball described here would have 600 different element slots, and therefore up to 600 different elements could be associated with a unique slot simultaneously, e.g., for display to a user in the soccer ball arrangement.

In some embodiments, users may purchase or otherwise acquire element rights to portions of “virtual real estate” in the arrangement, e.g., a grouping of elements or element slots. For example, a user 10 may purchase all 20 element slots associated with a single octagon of a soccer ball arrangement. The user may associate elements with the purchased slots. For example, the user 10 may associate 20 different elements to the 20 slots of a soccer ball. In some embodiments, a user may want to associate a larger or smaller number of elements with the real estate. For example, if the user has five different elements to associate with 20 different slots, the user may request to repeat one or more of the different elements so that they fill all 20 slots. In some embodiments, the user can request to re-size one or more elements, e.g., by expanding the size of an element, so that it takes up more “virtual real estate.”

In some embodiments, a number of elements may be associated with a smaller number of element slots. For example, 50 elements may be associated with 20 element slots. The elements may be displayed on a rolling basis. For instance, each time a page is refreshed, a new set of 20 of the 50 elements may be displayed in the 20 element slots.

In some embodiments, an arrangement (or portion thereof) may have a variable number of element slots. The number of slots may depend on the number of elements available for display in the slots. For example, a soccer ball arrangement having only 20 elements associated with it may be output with all 20 elements in a single hexagon of the soccer ball pattern, or it may be output with each element comprising an entire hexagon.

In other embodiments, a user may purchase an entire continent in an arrangement that simulates a three-dimensional representation of the planet earth. For example, an earth arrangement may have a theme of conserving energy, protecting the environment, and raising awareness of global warming. A single user may add elements to “fill up” the continent with elements. Users 10 may purchase elements to fill in any remaining element slots, e.g., in other continents and in the water corresponding to the earth arrangement.

In some embodiments, an element may be dynamically modified based on an intended arrangement. For example, if the arrangement requires white-colored elements to fill in the white portion of a checkered soccer ball, one or more elements may be assigned a white background before being “inserted” into the final design. For the earth example described above, a section that is arranged to appear as a portion of the Atlantic Ocean may be modified to appear as a blue section on the Earth mosaic, even if the picture uploaded by the user (or selected by the user from photos provided on the site) is a photo of a bright red Prius intended to promote the environmental benefits of hybrid vehicles. For elements comprising a video, a thumbnail may be dynamically extracted from the video that best corresponds to the desired color in the arrangement (such as blue for water). It should be appreciated that various video and other elements can be searched and modified to create a mosaic that minimizes the extent to which element preferences and characteristics are modified for the sake of the color scheme or other feature of the arrangement. For instance, the arrangement may have various parameters that define how “exact” the element color should correspond to the desired color.

Element position module 46 may determine an elements position within an arrangement. An element's position may be determined based on any element characteristic, including its identifier and the order in which it was created. In some embodiments, the elements created first will be positioned in the lowest position in an arrangement. Element positions may also be determined randomly. In some embodiments, an element may have a position associated during the creation or identification of the element. For instance, the first element created by a user 10 may have the first position in an arrangement.

Document format module 48 may format a document such as a webpage in connection with the output of a plurality of elements, e.g., according to an element arrangement.

Document output module 50 may output one or more elements, e.g., in the arrangement defined by Element arrangement module 44. The elements may be output in a webpage or other document or file, e.g., at a user's 10 computer. For instance, Element output module 54 may output elements so that they appear like bricks in a wall in a webpage displayed in a user's browser.

User selection module 52 may enable the display of one or more specific elements, e.g., at an end user 10 display device. User selection module 52 may enable users 10 to select a specific one (or more ) elements.

For instance, when a plurality of elements are displayed in a webpage or other document, each element in the page may comprise a hyperlink or other element identifier. Users 10 may select a specific element, e.g., by clicking on the image of the element. This functionality may be similar or identical to existing systems that enable a user to click on a specific image (such as an advertisement) in a webpage and thereby direct the user's browser to a network site associated with that image (e.g., a webpage associated with the advertised product).

Element output module 54 may enable the display of a one or more selected elements.

Element search module 56 may facilitate searching of a plurality of elements, e.g., based on search criteria. Search criteria may comprise keywords, element criteria and parameters (such as file size, image shape), and other criteria. In some embodiments, Element search module 56 may operate in a manner similar or identical to search engines well known in the art, such as those used at websites such as google.com (and images.google.com), yahoo.com, altavista.com, amazon.com, ebay.com, and other well-known websites.

Payment module 58 may enable users 10 to pay or otherwise transfer funds or other consideration to an entity associated with server 2, e.g., for products or services associated with an element associated with the user 10. For instance, a user 10 may pay a fee for the creation, uploading, and/or outputting of an element, e.g., at a network site. The consideration may be transferred to an entity associated with the creation, uploading, or outputting of an element, such as an owner or operator of a website that publishes a plurality of elements associated with a particular theme. In some embodiments, the consideration may be paid to an entity that provides software or other functionality that enables the creation, uploading, formatting, and/or publishing of one or more elements on a network site.

Email module 60 may communicate element information to one or more third parties. For instance, email module may enable a user 10 associated with an element (e.g., a user who creates an element) to send information associated with the element (such as a link to the element or an element identifier) to one or more other users 10, e.g., the user's 10 friends. After receiving the link or other information, the other users 10 may view the element, e.g., by clicking on the link.

Page server module 62 may output a document such as a webpage comprising one or more elements, e.g., to a user 10 browser or other entity.

Page navigation module 64 may enable users 10 to browse or navigate content at a network site that publishes one or more elements. For example, users 10 may navigate between multiple webpages of bricks, e.g., using links such as “next page” and “previous page.” Users 10 may also navigate specific elements. For example, users 10 may navigate from one element to another element, e.g., in an order in which the elements are displayed on a webpage. For example, if a webpage displays a plurality of elements as bricks in a wall, users may navigate from one “brick” element to an adjacent “brick” that is above, below, next to, or diagonally across from the brick. Element navigation may be controlled by links or other “buttons” displayed at the network site (such as a “next” arrow, or up, down, left, right, or diagonal arrow), a user's mouse, a user's keyboard, or other user input.

Concept Module 68 enables users 10 to identify one or more content-based concepts (e.g., keywords, subject matter, etc.) for association with the uploaded element. For example, a user 10 may identify multiple groups of concepts. Ads may be selected and displayed together with the elements based on the associated keywords. For instance, if an element is associated with the keyword “dog”, then an ad for dog food may be displayed in a webpage containing that element.

The modules of Server 430 may store, access and otherwise interact with various sources of data, including external data, databases and other inputs.

Other module 36 may have other functions.

A database 80 may be coupled to the server 2. The database 80 may comprise a plurality of databases as described below.

Keyword database 52 may store concepts such as keywords and other information that may be associated with one or more elements. For instance, keyword database may store information indicating that the words “Obama” and “President” are associated with an element comprising an image, wherein the image contains the words “Obama for President in 2008.”

Element identifier database 54 may store identifiers (e.g., unique identifiers) associated with a link. Element identifier database 54 may also store links associated with a specific element.

Element site database 56 may store information related to a website or other network site that outputs elements, such as the elements themselves.

Account database 58 may store information related to a user's account or an element.

Payment database 60 may store payment information (e.g., credit card information, amount and date information, and other information related to a purchase transaction) related to a purchase or other payment associated with an element (such as a purchase by a user of an element).

Illustrative System Environment

FIG. 1B depicts exemplary system 100 environments according to various embodiments of the invention. In these systems, only the server 2, users 10, and database 80 are shown. The other components may be linked to these components as shown in FIG. 1 via a network, e.g., a wireless network or the Internet. The system elements may communicate over http networks 14 and secure https networks 15, as well as other networks.

End users 10 may request and receive documents from providers 8 and server 2. The server 2 may provide documents such as advertisements to providers 8 and users 10.

In some embodiments, user computers 10 may comprise a verification crawler in accordance with the invention. User computers may obtain compliance criteria from server 2, access network sites of providers 8, determine whether the content of the network sites complies with various compliance criteria stored at the user computer 10 (or at server 2), and pass compliance information to server 2.

Further information about system 100 environments may be found in the U.S. Applications incorporated herein, above.

### Illustrative Process for Generating and Displaying an Element

FIG. 2 shows an exemplary flow chart for generating and displaying an element.

At block 205, a user 10 may create or upload one or more documents or files to the server 2. The documents or files may comprise one or more display elements. The document or file may also comprise information from which one or more elements may be extracted or otherwise determined. For example, the user 10 may upload a video of Barack Obama giving a speech and an image of George Bush scratching his head.

At block 210, element content may be generated, e.g., by Element creation module 28. For example, the user 10 may modify the Obama video and Bush image to create an element. For example, the user 10 may use text, image, and video-editing software such as Adobe PhotoShop to change the color, hue, brightness, image size, file type, and other characteristics of the video and image. The user may also modify the video by causing the image of George Bush to appear in each frame of the Obama video, so that it appears that Obama is speaking to George Bush while George Bush scratches his head. The user 10 may also add text to the video so that the caption “Obama is our man” appears during the second half of the video, e.g., when Obama speaks the phrase “we need new leadership in Washington.”

At block 215, an element may be extracted, e.g., from the created element content.

At block 220, the element may be formatted, e.g., by element format module 34.

At block 225, the element may be associated with an identifier, such as a unique identifier for uniquely identifying the element and distinguishing the element from other elements.

At block 230, the element may be associated with one or more keywords, e.g., based on the name of a file associated with the element or any text associated with the element.

At block 240, a user 10 may view and edit an element.

At block 245, a user may pay money associated with using the element.

At block 250, a user 10 may identify one or more other users 10 who may receive information about the element, such as a link to the element. For instance, a user may use a “tell a friend” feature.

At block 255, another user 10 may select and view user's 10 element.

At block 260, a user account may be created, e.g., by user account module 22.

At block 265, a cookie may be downloaded onto a user 10 computer.

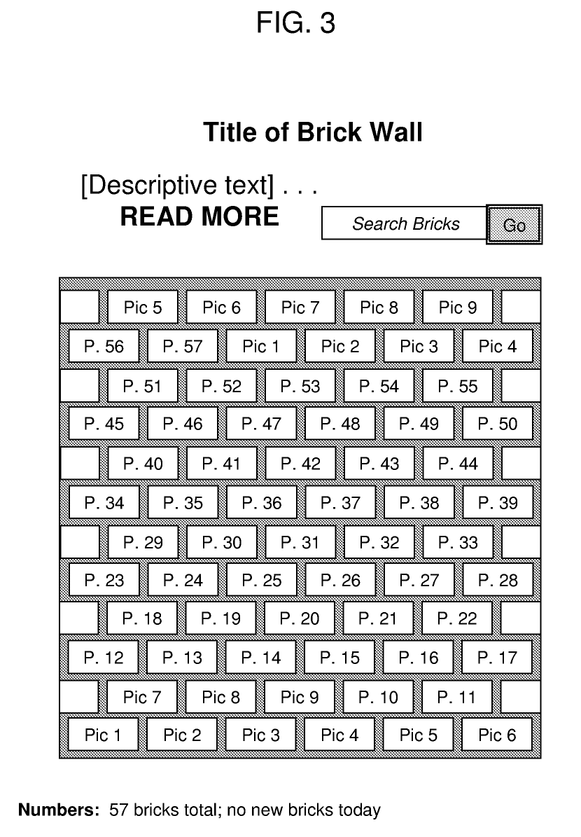

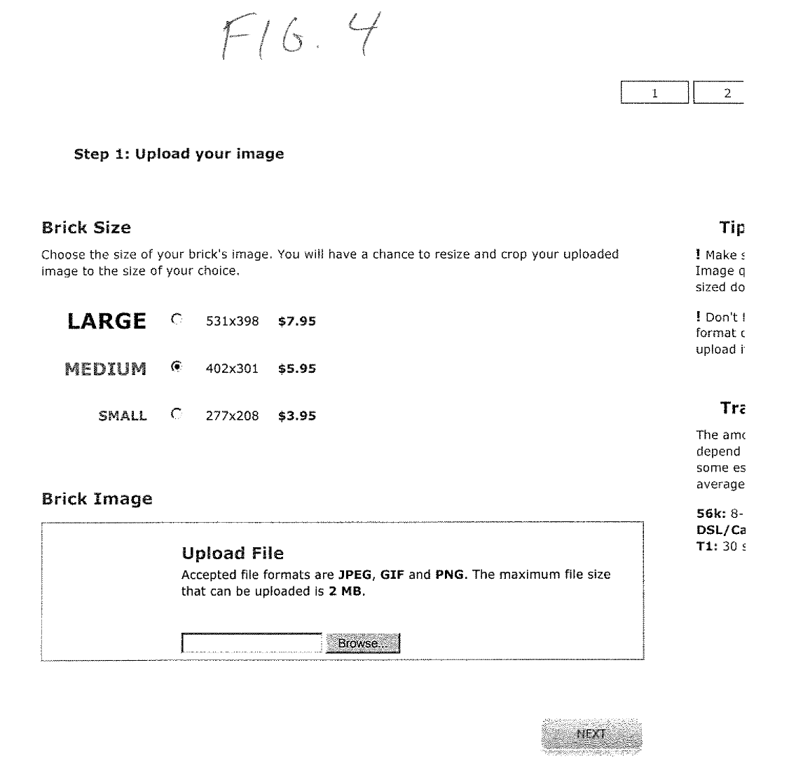

FIG. 3 shows an exemplary webpage 300 comprising a plurality of display elements arranged in a predetermined pattern according to an embodiment of the invention. Here, the plurality of image elements comprise thumbnails of larger images. Here, the webpage displays the thumbnails in a predetermined “brick wall” arrangement. Each display element is a single brick in the wall. Users may view a larger-file-size version of the display element (e.g., a full-motion video or a full-size image with corresponding text description) by clicking on the element or otherwise selecting the element.

In some embodiments, the page may be scrolled upward and downward to view image elements that appear above and below what is currently viewed or viewable on the page or on the user's display. For example, a user may use a cursor to “grab” the composite mosaic of display elements and move them up, down, left, right or diagonally across the user's browser, e.g., in a manner similar to “moving” a portion of a map in the program Google Maps (at www.maps.google.com).

In some embodiments, users may surf multiple pages of image elements. For example, there may be 1000 display elements available, but the webpage may be configured so that only the most recently created 256 display elements are displayed on a single page at a single time. The most recently created display element may be located at the far bottom left of the page, and the next-most-recent may be at the next position to the right.

The mosaic webpage 300 may have a search feature that enables users to search for elements. The search function may be used in a manner similar to other existing search technology, such as that used at websites such as www.yahoo.com, www.google.com, www.youtube.com, and www.images.google.com. For instance, users may search for a specific display element or a set of elements that may have a relevance or degree of relatedness to a particular keyword. For instance, users may search for the keywords “yellow Fender Stratocaster.” In accordance with the search algorithms employed by the search function in use, display elements associated with one or more of the terms “yellow,” “Fender,” and “Stratocaster” may be returned as search results. The search results may appear in a list of search results having a traditional format (e.g., similar to www.youtube.com or www.google.com search results), or they may appear based on a predetermined arrangement (such as a brick wall or other arrangement).

FIG. 4 shows an exemplary webpage for uploading an image according to an embodiment of the invention. As shown in FIG. 4, users may specify parameters of the display element, such as file size (e.g., based on number of pixels). Users may be charged different prices based on parameters such as size. For example, a higher price may be charged for a larger file size, as a larger file size occupies more memory and demands more system resources to display. As shown in FIG. 4, the webpage may comprise a window for uploading files, e.g., for another website or from the user's computer (e.g., from the user's hard drive).

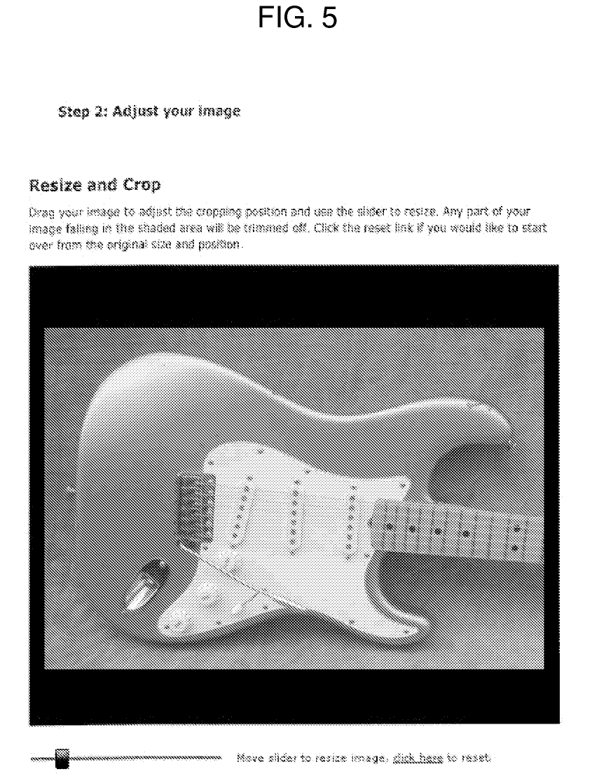

FIG. 5 shows an exemplary webpage for formatting an uploaded image according to an embodiment of the invention. As shown in FIG. 5, users may resize and crop an uploaded image. Programs such as Photoshop may also be used to format or otherwise modify images and other element data.

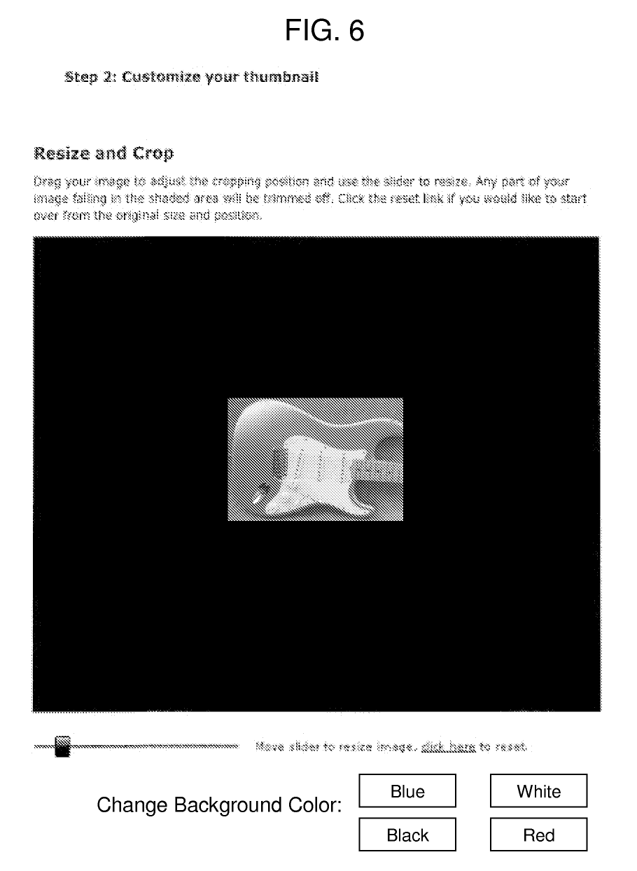

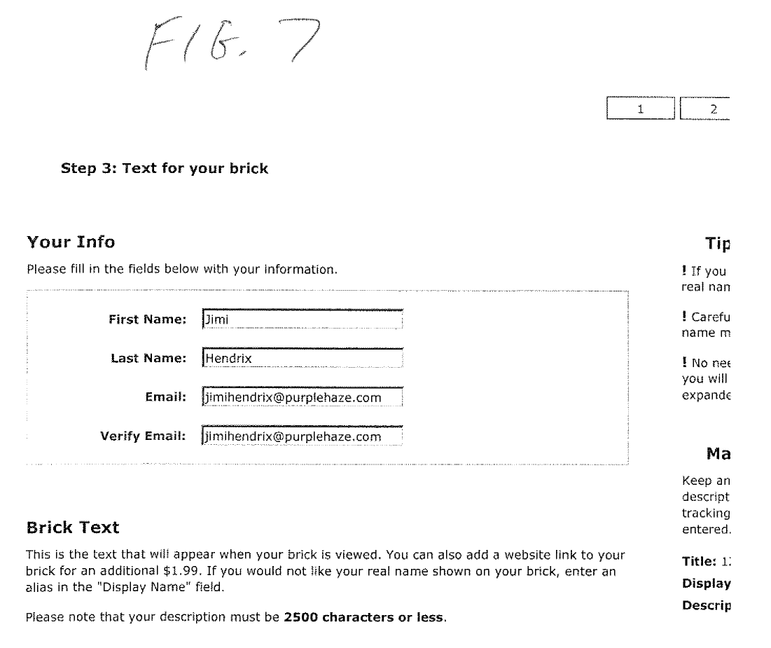

FIG. 6 shows an exemplary webpage for formatting a thumbnail of an output element according to an embodiment of the invention. As in FIG. 5, a thumbnail of the uploaded image may also be formatted.

In some embodiments, a thumbnail view is used for mosaic webpages comprising a plurality of elements, while an expanded view (as cropped in FIG. 5) is displayed when a particular element is selected.

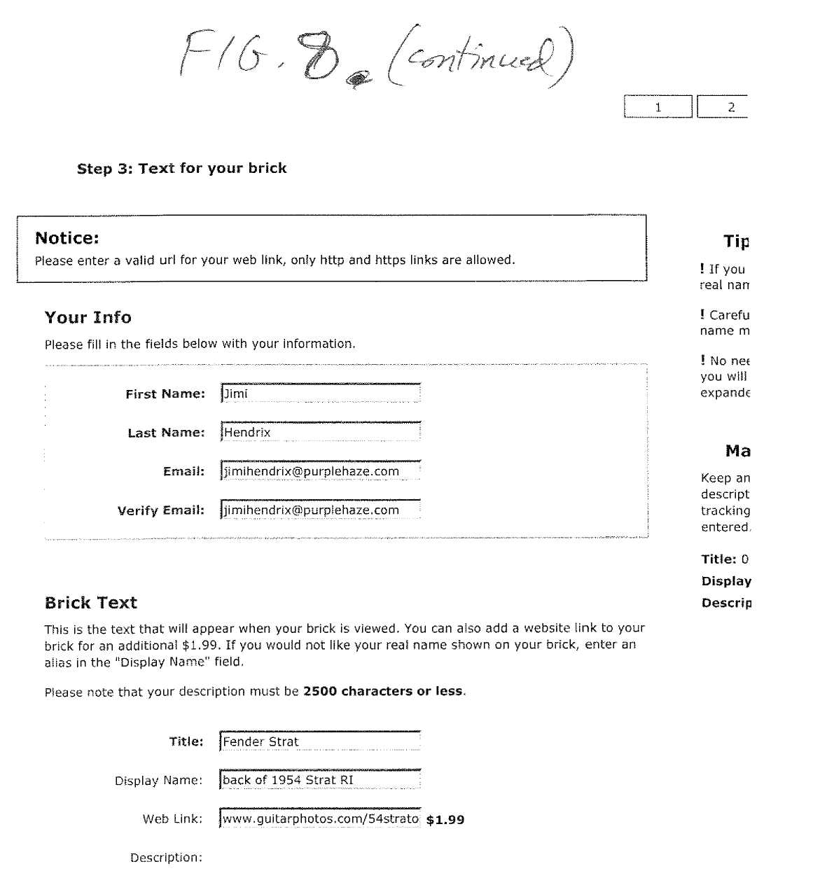

FIG. 7 shows an exemplary webpage for entering user information according to an embodiment of the invention. For instance, the user may enter user name, email address, and other personal data.

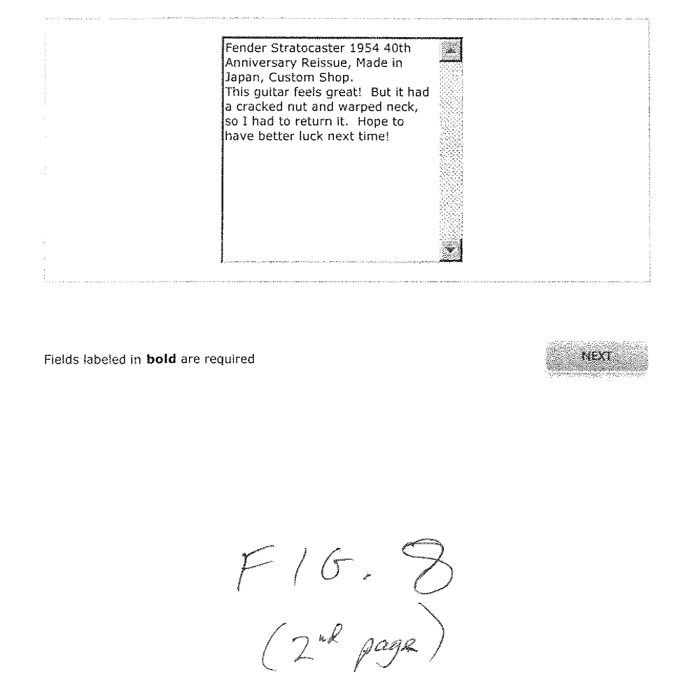

FIG. 8 shows an exemplary webpage for entering information about a display element according to an embodiment of the invention. As shown in FIG. 8, users may provide a title, display name, hyperlink, and textual description of the element. It should be noted that search algorithms may select search result elements based on this information. For example, if a user searches for the term “guitar,” the server 2 may return a list of thumbnail elements that have the word “guitar,” “guitars,” or “instrument” in the title or description. The search results may be displayed in such a way that reveals the portion of the title or description that was deemed relevant to the search, e.g., consistent with other search engines well known in the art.

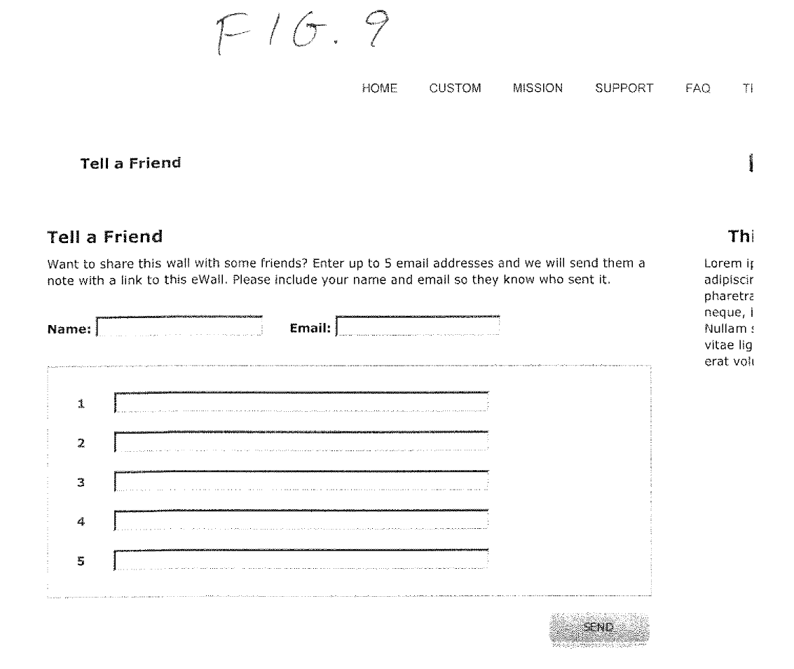

FIG. 9 shows an exemplary webpage for displaying a thumbnail and full-size version of a display element according to an embodiment of the invention.

It should be appreciated that in some embodiments, users may modify an image, description, or other user or element information after an element has already been defined and published. For example, a user may submit a new picture several months after initially purchasing and publishing an element at the server 2.

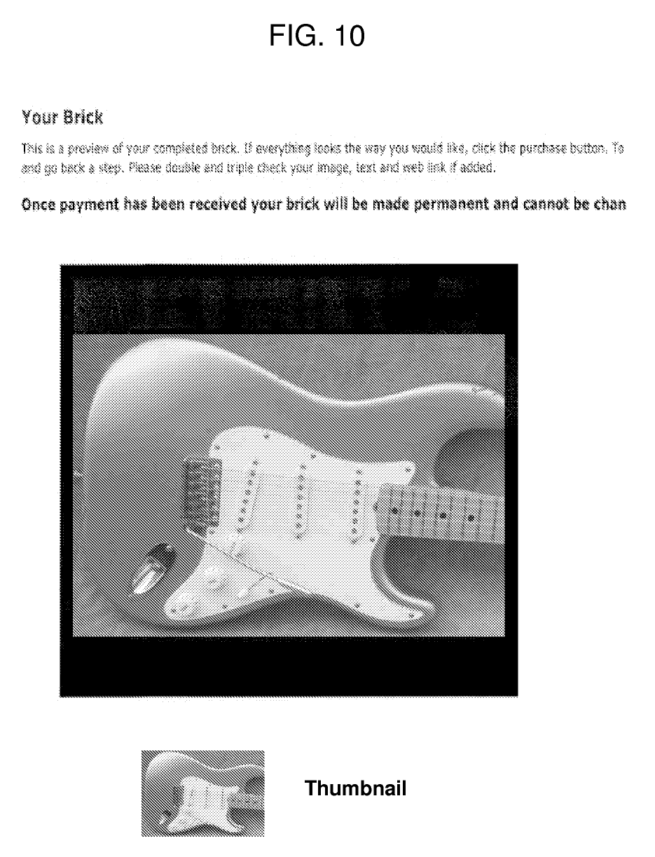

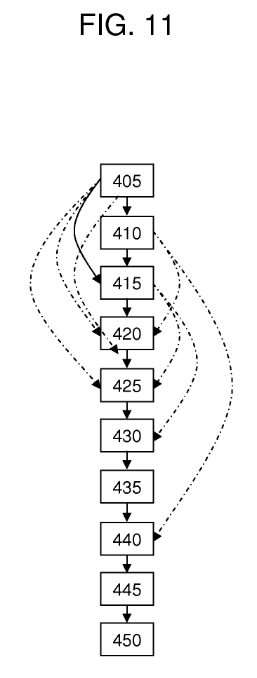

FIG. 10 shows an exemplary webpage for communicating to other users about a display element. For instance, users may “tell a friend” about an element that was created pursuant to FIGS. 4-9. A user may email or otherwise communicate element identifier information to one or more other users. The communication may include other information as well, such as a personal message from the user, a link, an image (such as a thumbnail or expanded view of the element), or other attached document. The element identifier may be a unique code or identifier associated with the element that enables the server 2 and/or users to locate and view the specific element. In some embodiments, the communication may comprise a link which, when selected, takes a browser to a webpage comprising an expanded view of the element. A communicated link may alternately or additionally direct a web browser to a webpage comprising a composite mosaic wherein the specific element is highlighted or otherwise singled out. In this way, a user may enable other users to easily locate a specific link.

It should be appreciated that in some embodiments, users may communicate links or other identifiers regarding other elements that have no prior association with the user. For instance, a user may find a particularly noteworthy element from among a plurality of elements. The user may then send an element identifier to other users so that the other users can quickly find and view the noteworthy element.

FIG. 4 shows an exemplary flow chart for outputting a plurality of elements at a network site.

At block 405, a user 10 may select an element arrangement, e.g., from a list of element arrangements.

At block 410, the server 2 may receive a request for a webpage containing a plurality of elements. For instance, a user may request a page comprising elements associated with Barack Obama in connection with a Presidential election.

At block 415, elements may be selected for display.

At block 420, elements may be selected and arranged for output in the webpage, e.g., according to predetermined element arrangement selected by the user 10.

At block 425, a document such as a webpage comprising selected elements in the element arrangement may be formatted.

At block 430, the webpage may be outputted, e.g., to containing selected elements arranged in the selected predetermined arrangement.

At block 435, a user 10 may scroll through and zoom elements.

At block 440, a user 10 may search among a plurality of elements.

At block 445, a user 10 selects a specific element for expanded display. The element may be an element associated with the user for display.

At block 450, a user locates and requests an element, such as an element previously updated and edited by user 10.

It should be appreciated that the actions described at the blocks in the above-referenced flow charts may be performed in any order, and they need not all be performed in a single embodiment.

It should be understood that the server, processors, and modules described herein may perform their various functions (e.g., arranging elements into a mosaic such as a brick wall) automatically or via an automated system. As used herein, the term “automatically” refers to an action being performed by any machine-executable process, e.g., a process that does not require human intervention or input.

The embodiments of the present inventions are not to be limited in scope by the specific embodiments described herein. For example, although many of the embodiments disclosed herein have been described with reference to images and webpages, the principles herein are equally applicable to other any file and system that enables a user to provide content that can be output to users together with content provided by other users. Indeed, various modifications of the embodiments of the present inventions, in addition to those described herein, will be apparent to those of ordinary skill in the art from the foregoing description and accompanying drawings. Thus, such modifications are intended to fall within the scope of the following appended claims.

Further, although the embodiments of the present inventions have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein.

It should be noted that the additional notes and other materials attached hereto, including the “A and B” claims below, should not be construed to limit the embodiments of the invention in any way. The notes and other materials are intended to describe various non-limiting embodiments of the invention.

What is claimed is:

1 . A method of outputting a plurality of display elements at a network site, comprising:
prompting a plurality of users to enter element data;
receiving element data from each of the plurality of users;
generating a plurality of display elements based on the corresponding element data;
storing element information related to each of the display elements;
receiving a request from a user for a plurality of display elements; and
responsive to the request:
selecting a plurality of display elements for output to the user based on the stored element information;
determining an output arrangement for the plurality of selected display elements based on a predetermined arrangement algorithm; and
outputting the plurality of selected display elements at a network site so that the plurality of selected display elements are configured to be displayed to the user in the output arrangement, the output arrangement comprising a geometrically-defined mosaic of display elements.

2. The method of claim 1, wherein the output arrangement is configured to emulate a physical object, the plurality of display elements being collectively displayed in a manner that emulates the physical object, each display element comprising a portion of the emulated physical object.

3. The method of claim 1, wherein the plurality of elements are images.

4. The method of claim 1, wherein the elements comprise images, further comprising:
selecting an image of an element; and
displaying an expanded view of the selected image.

5. The method of claim 1, wherein at least one of the display elements comprises a thumbnail of a video.

6. The method of claim 1, wherein the element information comprises at least one video file, wherein the plurality of display elements comprises at least one single image, and wherein the act of identifying a plurality of display elements comprises identifying the single image from the video file.

7. The method of claim 1, wherein the output arrangement comprises at least one of a substantially spherical mosaic and a brick wall-shaped mosaic.

8. The method of claim 1, further comprising:
prompting the user to format a display element associated with the element data provided by the user.

9. The method of claim 1, further comprising:
scaling the image to a predetermined size associated with a plurality of display elements.

10. The method of claim 1, further comprising:
prompting the user to format a display element associated with the element data provided by the user; and
scaling an image associated with the element.

11. The method of claim 1, further comprising:
receiving from a user a selection of a position of an element in the output arrangement.

12. The method of claim 1, wherein outputting the plurality of selected display elements causes the display elements to output in a concatenated manner.

13. The method of claim 1, further comprising:
receiving user identification information from at least one of the plurality of users; and
establishing a user account for the at least one of the plurality of users, wherein the user account stores information about at least one specific user and at least one specific element.

14. The method of claim 1, further comprising:
amending a display element by a user.

15. The method of claim 1, further comprising:
receiving a request from the user for one or more elements associated with one or more keywords;
identifying one or more elements associated with the one or more keywords; and
outputting to the user the one or more identified elements.

16. The method of claim 1, wherein the output arrangement is configured to emulate a mosaic shaped like an item of sporting equipment or a mosaic shaped like a logo associated with a school, company, or organization.

17. The method of claim 1, further comprising:
presenting a plurality of display arrangements to a user;
receiving a selection of a particular display arrangement; and
displaying elements according to the selected arrangement.

18. The method of claim 1, further comprising:
receiving image information from a user; and
creating an output arrangement corresponding to the geometry and color of the image.

19. The method of claim 1, further comprising:
displaying elements according to an arrangement created or selected by a user.

20. A system for outputting a plurality of display elements at a network site, comprising:
an output device for prompting a plurality of users to enter element data;
a receiver for receiving element data from each of the plurality of users and for receiving a request from a user for a plurality of display elements;
a processor for generating a plurality of display elements based on the corresponding element data, and, responsive to the request:
selecting a plurality of display elements for output to the user based on the stored element information;
determining an output arrangement for the plurality of selected display elements based on a predetermined arrangement algorithm; and
outputting the plurality of selected display elements at a network site so that the plurality of selected display elements are configured to be displayed to the user in the output arrangement, the output arrangement comprising a geometrically-defined mosaic of display elements; and
a database for storing the element information related to each of the display elements.
